(19) United States
(12) Patent Application Publication
(10) Pub. No.: US 2006/0061814 A1
(43) Pub. Date: Mar. 23, 2006

(54) Recording medium and print apparatus

(76) Inventor: Masahisa Tokunaga, Yokohama-shi (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/228,808

(22) Filed: Sep. 16, 2005

(30) Foreign Application Priority Data
Sep. 17, 2004 (JP) 2004-271719 (PAT.

(51) Int. Cl. G06F 3/12

(52) U.S. Cl. 358/1.15

(57) ABSTRACT

A recording medium such as paper on which an image can be printed by a print apparatus includes an RFID (Radio Frequency Identification) tag such as an IC tag for recording data comprising original image data and print setting information used upon printing. A print apparatus reads out the original image data and the print setting information from the RFID tag and executes the printing on the basis of them. Even in the case of an image subjected to a print effect processing, reprinting with the same picture quality can be easily performed and a trouble of searching for the image can be saved.

### BACKGROUND OF THE INVENTION

1. Field of the Invention

The invention relates to a recording medium, a print apparatus, a printing method, and a computer program for printing an image.

2. Related Background Art

The number of individual users who print photographs is increasing owing to the widespread of a digital camera and the realization of high picture quality of color printers. In printing, the user often prints the photograph while changing quality of a print image to a favorite color taste or the like.

The number of cases where the printed photographs are reprinted after photographing with the digital camera in a manner similar to the case of conventional silver salt photographs is also increasing. In this case, to reprint the photograph, first, the user searches for image data on a personal computer while looking at the image of the photograph on a screen, presumes print setting information for printing the image data from the photograph, determines it, and prints the photograph image. However, there is a case where the determined print setting information differs from that of the original printing of the photograph, so that the user has to compromise on the unsatisfactory photograph or determine the print setting information over again and print many times until the original photograph can be printed.

Although a combination of the digital camera and the printer or a combination of the personal computer and the printer is considered as a system of printing, in both of the above cases, the user cannot search for a recording medium itself which stores the images used for the original printing of the photographs, so that the user is annoyed by this situation.

Since print quality of a printed matter deteriorates with the elapse of time, the user wants to reprint it. However, also with respect to such a requirement, it is difficult to completely reproduce a print effect at a point of time of the previous printing according to the conventional technique.

As means for solving those problems, the means constructed in such a manner that an object is photographed by a photographing apparatus having a printer therein and, while a photographed image is printed onto a recording medium having an IC tag therein, image data and photographing information are recorded to the recording medium, thereby enabling the image data to be easily searched for from the photographed image has been disclosed in Japanese Patent Application Laid-Open No. 2004-72146.

According to the Official Gazette of Japanese Patent No. 2925199, although reprinting by a video printer can be easily performed, both of the photographed image and a video tape in which the original image data has been recorded have to be used.

However, according to Japanese Patent Application Laid-Open No. 2004-72146, although the image data can be easily searched for, such printing that a user's favorite trimming processing is executed or a color effect is added to the obtained image cannot be executed and the printing cannot be reconstructed more easily.

According to the Official Gazette of Japanese Patent No. 2925199, although the reproduction of the printing can be easily performed, two media such as photographed image and video tape in which the original image data has been recorded are necessary and, even if the photograph exists, it is not easy to find the video tape on which the photograph has been recorded.

### SUMMARY OF THE INVENTION

It is an aspect of the invention to solve all or at least one of the foregoing problems.

According to one aspect of the invention, even in an image subjected to a print effect processing such as trimming processing, color effect, or the like, it can be easily reprinted with same picture quality and a trouble of searching for the image can be saved.

According to another aspect of the invention, a recording medium of the invention on which an image can be printed comprises: a storing unit for recording image data corresponding to the printed image and print setting information upon printing; and a communication unit for reading out the image data and the print setting information.

Further other objects and features of the invention will be obviously understood from the description of the following embodiments and drawings.

### BRIEF DESCRIPTION OF THE DRAWINGS

FIG. 1 is a diagram showing a recording medium for printing to which the invention is applied;

FIG. 2 is a block diagram showing a construction of a print apparatus;

FIG. 3 is a diagram showing a constructional example in the case where a digital camera is used as a print host;

FIG. 4 is a flowchart showing a sequence in the case where an arbitrary image reproduced by the digital camera and displayed on a display apparatus is printed;

FIG. 5 is a diagram for explaining trimming;

FIG. 6 is a flowchart showing a sequence in the case where the print apparatus prints the image and writes original image data and print setting information into an RFID tag;

FIG. 7 is a cross sectional view showing a specific constructional example of the print apparatus; and

FIG. 8 is a flowchart showing a sequence for allowing the print apparatus to reprint.

### DETAILED DESCRIPTION OF THE PREFERRED EMBODIMENT

A preferred embodiment of the invention will be described hereinbelow with reference to the drawings.

Printing and Recording

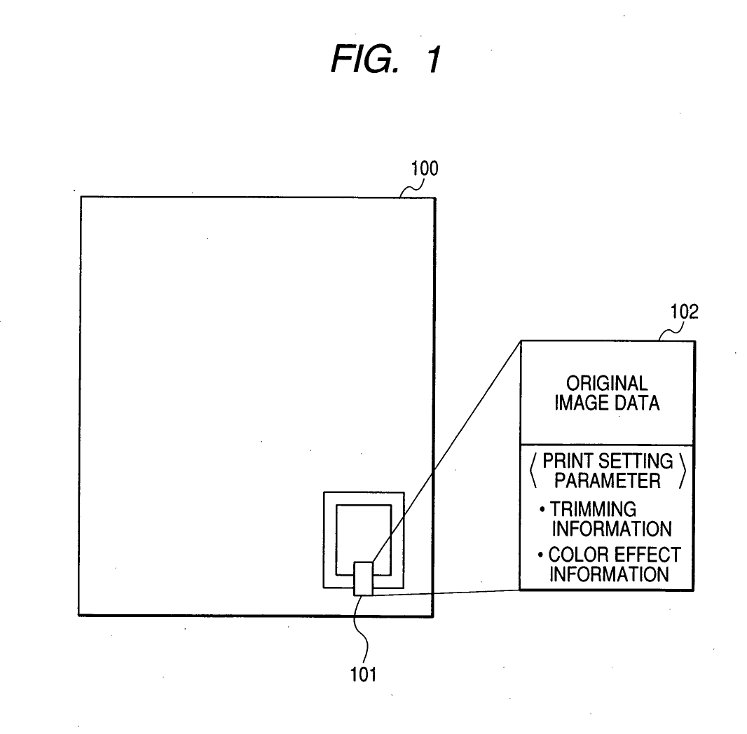

FIG. 1 shows a recording medium for printing to which the invention is applied. Reference numeral 100 denotes a recording medium such as paper or the like which is printable by a print apparatus. The recording medium 100 has an RFID (Radio Frequency Identification) tag 101 such as an IC tag or the like for recording data 102 comprising original image data and print setting information used upon printing.

The RFID tag 101 is constructed by: an IC chip having functions provided by a storing unit for storing the image data, the print setting information, and the like, a transmitting unit, a receiving unit, and the like; and a coil-shaped antenna (communication unit) connected to the IC chip. The data 102 is recorded in the storing unit of the IC chip. The RFID tag 101 is built in the surface of the recording medium 100 so that it cannot be seen. In this case, it is preferable that a mark or a character for recognizing that the RFID tag 101 has been embedded is recorded on the surface (reverse surface) different from the print surface of the image. Although it is convenient to allow the position of the RFID tag 101 to be easily recognized in order to reconstruct the image as mentioned above, it is undesirable to superimpose some mark, character, or the like onto the image. Therefore, if the mark, character, or the like is written on the surface (reverse surface) different from the print surface of the image, the position of the RFID tag 101 to preproduce the image can be easily recognized without deteriorating the print quality.

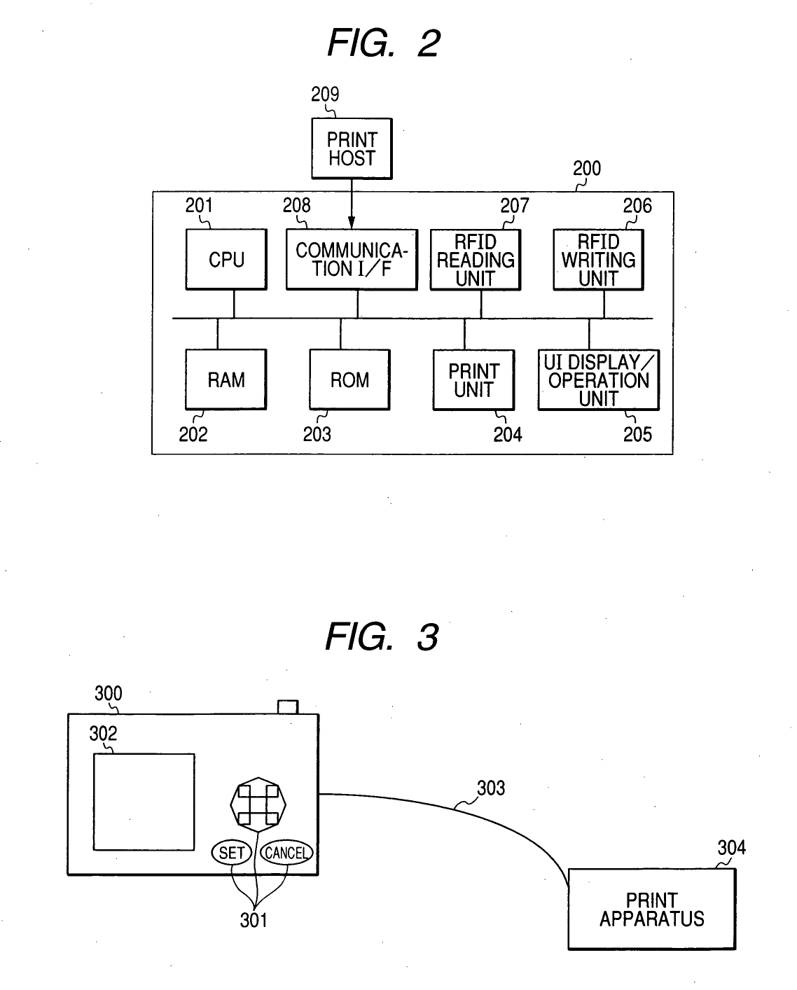

FIG. 2 is a diagram showing a construction of a print apparatus 200 which can print onto the recording medium 100, record the data 102 into the RFID tag 101, and read out the data 102 therefrom.

Reference numeral 201 denotes a CPU for making central control of the print apparatus 200; 204 a print unit for printing onto the recording medium; and 205 a UI (User Interface) display/operation unit for allowing the user to enter a print setting and displaying the print setting, a print situation, or an error indication.

Reference numeral 206 denotes an RFID writing unit for writing the original image data and the print setting information into the RFID tag 101 provided for the recording medium 100 and 207 indicates an RFID reading unit for reading out the original image data and the print setting information recorded in the RFID tag 101.

Reference numeral 208 denotes a communication unit which is connected to and communicates with a print host 209 for transmitting the print setting information showing how to print the original image data by the print apparatus 200.

Reference numeral 203 denotes a ROM for storing at least programs for: print control of the print unit 204; display control of the UI display/operation unit 205; operation unit control; RFID writing control of the RFID writing unit 206; RFID reading control of the RFID reading unit 207; control of communication with the print host 209 using the communication unit 208; analysis control of the data received through the communication unit 208; and control to image-process the image data in accordance with the print setting information.

Reference numeral 202 denotes a RAM for storing temporary data which is used for: the print control of the print unit 204; the display control of the UI display/operation unit 205; the operation unit control, the RFID writing control of the RFID writing unit 206; the RFID reading control of the RFID reading unit 207; the control of communication with the print host 209 using the communication unit 208; the analysis control of the data received through the communication unit 208; and the control to image-process the image data in accordance with the print setting information.

A well-known protocol is used as a print communication control protocol which is used for the print apparatus 200 and the print host 209, to transmit and receive the original image data and the print setting information and request a print start. An image format which can be interpreted by the print apparatus is JPEG and TIFF. A format of print effect information is an XML format. A USB is used as a physical communication bus.

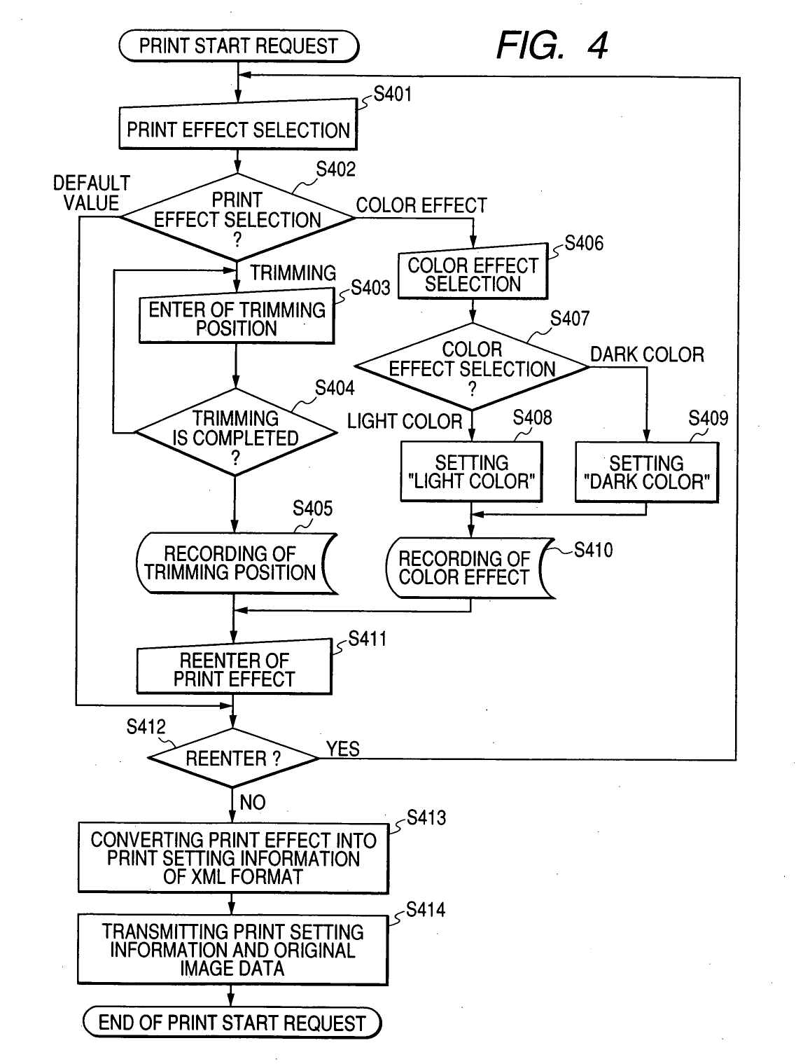

In FIG. 3, reference numeral 300 denotes a digital camera having operating members 301 and a display apparatus 302 for displaying a reproduction image and characters/symbols. An image recording medium (not shown) can be loaded into the digital camera main body. Image data recorded on such an image recording medium is reproduced and displayed and can be printed by a print apparatus 304 (corresponding to the print apparatus 200) through a USB cable 303.

A sequence for starting the printing in the case where the digital camera 300 is assumed to be the print host 209 in FIG. 2 will now be described.

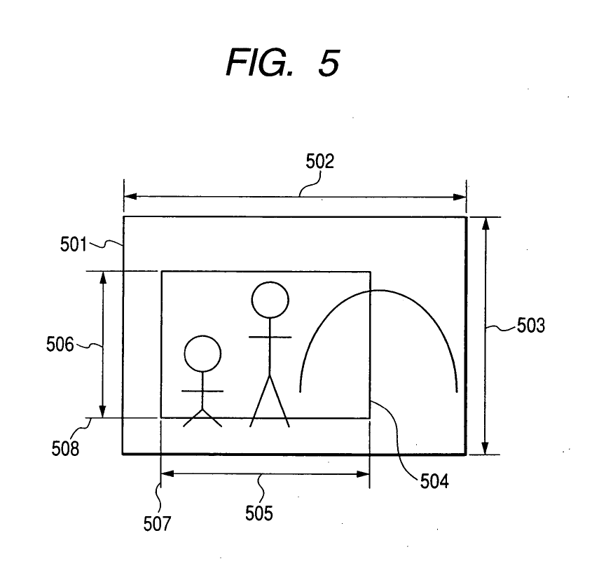

FIG. 4 shows the sequence in the case where an arbitrary image is reproduced by the digital camera 300 and displayed on the display apparatus 302 is printed. The digital camera 300 waits until the user enters the selection of the print effect (step S401). Whether the desired print effect has been selected or a default value is used is discriminated (step S402).

There are trimming and a color effect as the print effect. If the print effect indicates the trimming, trimming information is entered by using an operation unit provided for the digital camera 300 (step S403). After completion of the setting of the trimming information (step S404), the trimming information is held (step S405). If it is necessary to determine the trimming information over again, the processing routine is returned to step S403 and the trimming information is reentered.

If the print effect indicates the color effect, either “light color” or “dark color” is selected and entered by the user (step S406). The selected color effect is discriminated (step S407). If the selected color effect indicates the “light color”, the “light color” is set as a color effect (step S408). If the selected color effect indicates the “dark color”, the “dark color” is set as a color effect (step S409). The set color effect is held (step S410).

After that, the apparatus waits until the user enters whether or not the set print effect is reset (step S411). Whether or not the print effect is reentered is discriminated (step S412). If the print effect is entered again, the processing routine is returned to step S401. If there is no need to reenter, the trimming information and the color effect which have been set by the user or the trimming information and the color effect as default values are converted as the print setting information into the XML format which can be interpreted by the print apparatus 200 (step S413). The converted print setting information and original image data are transmitted to the print apparatus 200 (step S414).

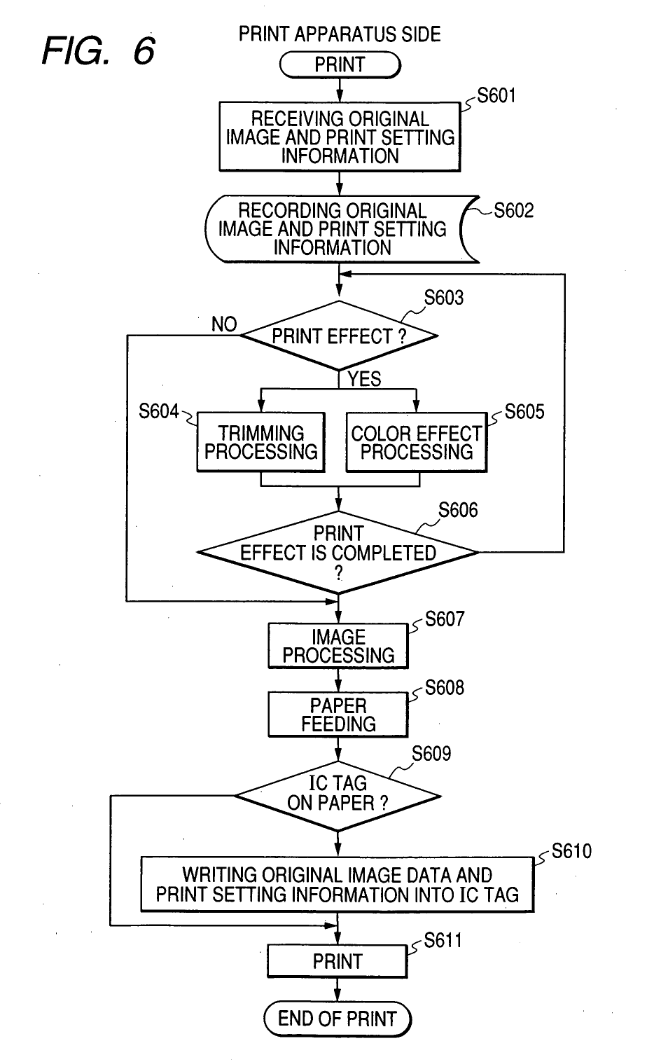

The trimming information will now be described with reference to FIG. 5. Reference numeral 501 denotes an original image having dimensions of an original image lateral width 502 and an original image vertical width 503, and 504 indicates a trimming frame having dimensions of a trimming lateral width 505 and a trimming vertical width 506. A left lower position of the trimming frame 504 is located to a trimming lateral position 507 and a trimming vertical position 508 of the original image 501. The original image lateral width 502, original image vertical width 503, trimming lateral width 505, trimming vertical width 506, trimming lateral position 507, and trimming vertical position 508 are totally regarded as trimming information. If the trimming information exists, the same image can be always trimmed and extracted from the original image data.

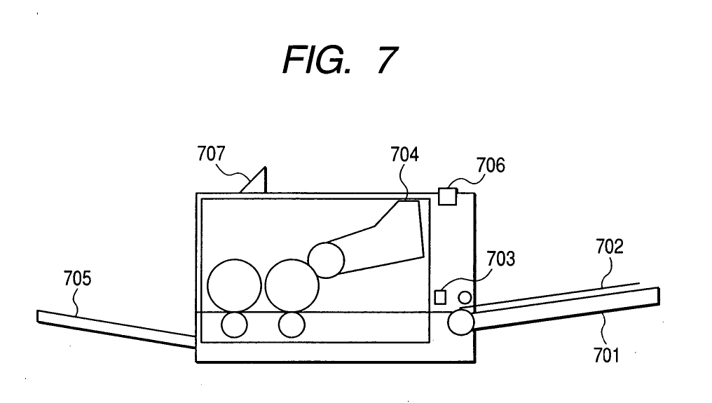

FIG. 6 shows a sequence in the case where the original image data and the print setting information formed by the digital camera 300 are received through the communication unit 208, the print apparatus 200 prints the image, and the original image data and the print setting information are written into the RFID tag 101.

The original image data and the print setting information formed by the digital camera 300 are received through the communication unit 208 (step S601) and temporarily stored (step S602). The presence or absence of the print setting information is discriminated (step S603). Thus, if the trimming has been set as a print effect, a trimming processing to extract the trimming frame portion 504 as primary image data from the original image data as shown in FIG. 5 by using the trimming information which the received print setting information has is executed (step S604). If the color effect has been set as a print effect, a color effect processing is executed (step S605). If the “light color” has been set as, a color effect, a color taste conversion is executed so that the print image is printed in a light color as a whole. In the case of the “dark color”, the color taste conversion is executed so that the print image is printed in a dark color as a whole.

Whether or not all of the print effects have been processed is discriminated (step S606). If they have completely been processed, a processing to form secondary image data to be printed by using the print unit 204 of the print apparatus 200 is executed to the primary image data (step S607).

Subsequently, the recording medium conveyed to the print apparatus 200 is fed (step S608) and whether or not the fed recording medium has the RFID tag 101 is discriminated (step S609). Thus, in the case of the recording medium 100 having the RFID tag 101, the original image data and the print setting information corresponding to the print target image data are written into the RFID tag 101 in the format received by the print apparatus 200 (step S610). The printing of the image data for printing, formed in step S607 by the print unit 204 is executed (step S611).

Thus, the image designated by the user with the digital camera 300 is printed onto the recording medium 100 by using the print apparatus 200 on the basis of the user's desired print setting information. A printed matter which records the printed original image data and the print setting information can be formed.

Although the present embodiment has been described by using the RFID tag 101 provided for the recording medium 100, the embodiment can be also realized by a contactless storing medium. Although the trimming effect and the color effect have been described as print setting information, other well-known print effects such as both-sided print effect, setting effect of a color mode such as monochromatic print, monocolor print, sepia color print, or the like, VIVID effect to vividly correct the color, and the like can be also used.

Although the case of using the digital camera 300 as a print host 209 has been described above, naturally, it can be also easily realized by a personal computer having similar communicating means.

Reprint

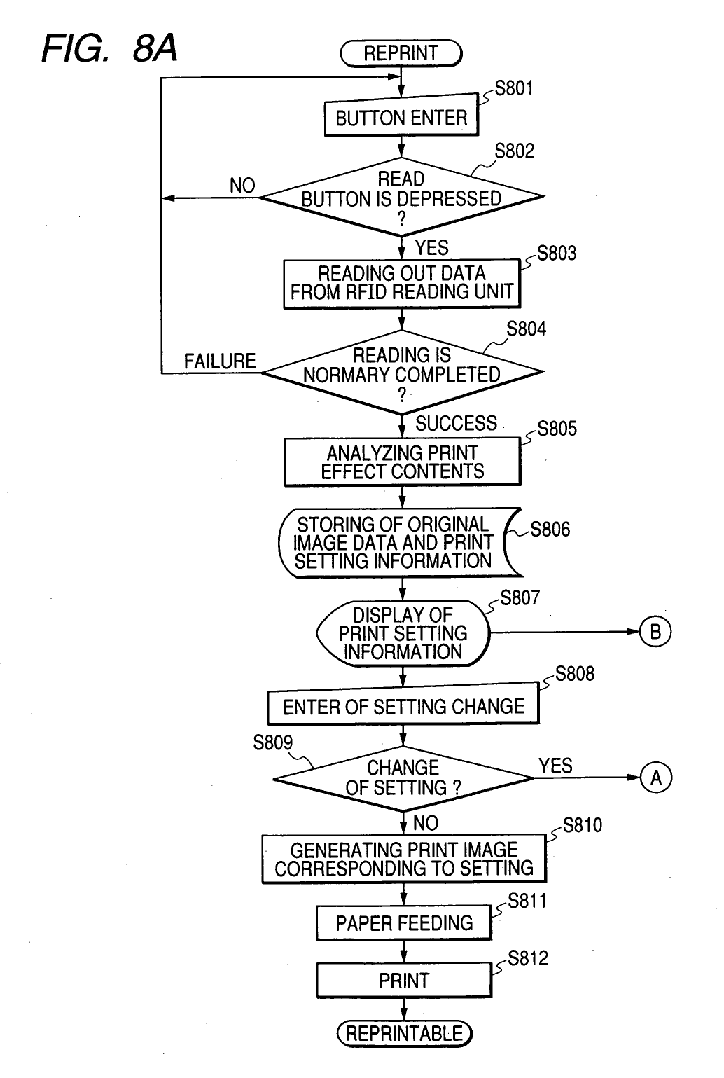

An example of reprinting by using a printed matter on which the original image data and the print setting information have been recorded in the RFID tag 101 will now be described. FIG. 7 is a cross sectional view showing a specific constructional example of the print apparatus 200. Reference numeral 701 denotes a paper pick-up tray; 702 a recording medium (refer to FIG. 1) having the RFID tag; 703 an RFID writing apparatus for writing the original image data and the print setting information into the RFID tag; 704 a print unit; 705 a paper output tray; 706 an RFID reading unit for reading the original image data and the print setting information from the RFID tag; and 707 a UI display/operation unit for setting the user who uses the print apparatus, displaying its status, and displaying an error.

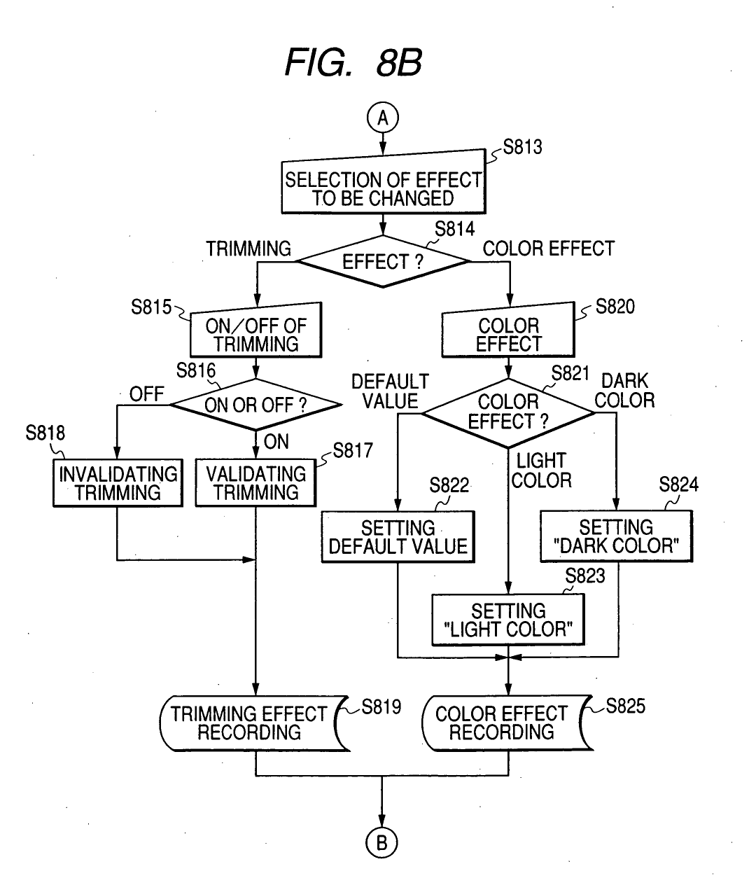

FIG. 8 shows a sequence for allowing the printed matter having the original image data and the print setting information which have been recorded and printed by the print apparatus 200 by using the recording medium 100 to approach the RFID reading unit 706 to cause the print apparatus 200 to reprint them.

When a “read button” (not shown) provided for the UI display/operation unit 707 is depressed by the user (step S801), whether or not the “read button” has been depressed is discriminated (step S802). If YES, the data is read out by the RFID reading unit 706 (step S803).

After that, whether or not the reading operation has normally been completed is discriminated (step S804). If the reading operation fails, the processing routine is returned to the process for depressing the button of step S801. If the reading operation has normally been finished, a contents analysis is performed to extract the original image data and the print setting information from the read data (step S805). The extracted original image data and print setting information are stored (step S806). The extracted print setting information is displayed by the UI display/operation unit 707 (step S807) to cause the user to enter whether or not the print setting information is changed (step S808). Whether or not the print setting information is changed is then discriminated (step S809).

If there is no change in the print setting information, processes similar to those of steps S601 to S606 described in FIG. 6 are executed (step S810). The recording medium enclosed on the paper pick-up tray 701 is fed (step S811). The image-processed image data is printed onto the recording medium (step S812).

On the contrary, if there is a change in the print setting information, the print effect which changes the print setting information is selected and entered (step S813). The selected and entered print effect is discriminated (step S814). If the selected print effect to be changed indicates the trimming, whether or not the user has entered ON/OFF of the trimming is discriminated (steps S815, S816). If the trimming is ON, the trimming effect of the print setting information is validated (step S817). If it is OFF, the trimming effect of the print setting information is invalidated (step S818). The trimming effect of the print setting information is recorded (step S819).

If the selected print effect to be changed indicates the color effect, the apparatus allows the user to select the color effect (step S820). The selected entering item is discriminated (step S821). If the selected color effect indicates the default value, the color effect is set to the default value (step S822). If the selected color effect indicates the “light color”, it is set to the “light color” (step S823). If the selected color effect indicates the “dark color”, it is set to the “dark color” (step S824). Either the “light color” or the “dark color” is recorded as a color effect (step S825).

When the print setting information is changed, the print setting information is displayed (step S807). If it is determined that no charge of the setting has been entered (step S809) in the process for entering a change of the print setting information (step S808), the processes similar to those of steps S601 to S606 described in FIG. 6 are executed (step S810). The recording medium enclosed on the paper pick-up tray 701 is fed (step S811). The image-processed image data is printed onto the recording medium (step S812).

Although the print sequence in which the depression of the read button (step S801) is used as a trigger has been described in the present embodiment, it is also possible to automatically detect the RFID tag 101 provided for the recording medium 100 and use it as a trigger for the printing.

Naturally, the objects of the invention are also accomplished by a method whereby the storing medium in which program codes of software to realize the functions of the embodiment mentioned above have been recorded is supplied to a system or an apparatus and a computer (or a CPU or an MPU) of the system or apparatus reads out and executes the program codes stored in the storing medium.

In such a case, the program codes themselves read out of the storing medium realize the functions of the embodiment mentioned above. The program codes themselves and the storing medium in which the program codes have been stored construct the invention.

As a storing medium to supply the program codes, for example, a flexible disk, a hard disk, an optical disk, a magnetooptic disk, a CD-ROM, a CD-R, a magnetic tape, a non-volatile memory card, a ROM, or the like can be used.

Naturally, the invention incorporates not only the case where the computer executes the read-out program codes, so that the functions: of the embodiment mentioned above are realized but also the case where an OS (a basic system or an operating system) or the like which is operating on the computer executes a part or all of actual processes on the basis of instructions of the program codes and the functions of the embodiment mentioned above are realized by those processes.

Further, naturally, the invention also incorporates the case where the program codes read out of the storing medium are written into a memory provided for a function expanding board inserted into the computer or a function expanding unit connected to the computer, after that, a CPU or the like provided for the function expanding board or the function expanding unit executes a part or all of actual processes on the basis of instructions of the program codes, and the functions of the embodiment mentioned above are realized by those processes.

The invention is not limited to the foregoing embodiment but many variations and modifications are possible within the scope of claims of the invention.

This application claims priority from Japanese Patent Application No. 2004-271719 filed on Sep. 17, 2004, which is hereby incorporated by reference herein.

What is claimed is:

1. A recording medium on which an image can be printed, comprising:
a storing unit adapted to record image data corresponding to the printed image and print setting information upon printing; and
a communication unit adapted to read out said image data and said print setting information.

2. A medium according to claim 1, wherein said print setting information includes at least one trimming information and a color effect.

3. A medium according to claim 1, wherein said storing unit and said communication unit are an RFID tag.

4. A medium according to claim 1, wherein a mark or a character for recognizing that said communication unit has been embedded is recorded on a surface of the recording medium on the side different from the image-printed surface.

5. A print apparatus comprising:
a print unit adapted to print an image onto a recording medium including a storing unit and a communication unit; and
a writing unit adapted to write image data corresponding to the image printed by said print unit and print setting information upon printing into said communication unit.

6. A print apparatus comprising:
a reading unit adapted to read out image data and print setting information from a recording medium including a storing unit in which the image data corresponding to a printed image and the print setting information upon printing have been recorded, and a communication unit for reading out the contents stored in said storing unit; and
a print unit adapted to execute the printing on the basis of the image data and the print setting information read out by said reading unit.

7. An apparatus according to claim 5, wherein said print setting information includes at least one trimming information and a color effect.

8. An apparatus according to claim 6, wherein said print setting information includes at least one trimming information and a color effect.

9. An apparatus according to claim 5, wherein said communication unit is an antenna of an RFID tag.

10. An apparatus according to claim 6, wherein said communication unit is an antenna of an RFID tag.

11. A printing method comprising the step of:
printing an image onto a recording medium including a storing unit and a communication unit for reading out contents stored in said storing unit; and
writing image data corresponding to the printed image and print setting information upon printing into said storing unit.

12. A printing method comprising the steps of:
reading out image data and print setting information from a recording medium including a storing unit in which the image data corresponding to a printed image and the print setting information upon printing have been recorded, and a communication unit for reading out the contents stored in said storing unit; and
executing the printing on the basis of the image data and the print setting information which are read out.

13. A computer program for causing a computer to execute processes for controlling a print apparatus, wherein said processes comprise:
printing an image onto a recording medium including a storing unit and a communication unit; and
writing image data corresponding to the printed image and print setting information upon printing into said storing unit.

14. A computer program for causing a computer to execute processes for controlling a print apparatus, wherein said processes comprise:
reading image data and print setting information from a recording medium including a storing unit in which the image data corresponding to a printed image and the print setting information upon printing have been recorded, and a communication unit; and
executing the printing on the basis of the image data and the print setting information which are read out.
